(19) United States
(12) Patent Application Publication
(10) Pub. No.: US 2007/0025794 A1
(43) Pub. Date: Feb. 1, 2007

(54) A PRINTER

(76) Inventors: Dale K. Kubin, Farmington Hills, MI (US); Nathan P. Scherdin, Farmington Hills, MI (US)

Correspondence Address: DOBRUSIN & THENNISCH PC, 29 W LAWRENCE ST, SUITE 210, PONTIAC, MI, 48326, US

(21) Appl. No.: 11/424,397

(22) Filed: Jun. 15, 2006

Related U.S. Application Data
(60) Provisional application No. 60/691,654, filed on Jun. 17, 2005.

(51) Int. Cl. B41J 11/50

(52) U.S. Cl. 400/605

(57) ABSTRACT

The present invention provides a printer for printing to multiple forms of media and/or along multiple media paths, which may be through the use of a moveable print head and optionally may include one or more digital recording devices for recording information to certain forms of media.

### PRIORITY CLAIM

To the extent applicable, the present invention claims the benefit of the priority of U.S. Provisional Application Ser. No. 60/691,654, filed Jun. 17, 2005, the contents of which are incorporated by reference herein.

### FIELD OF THE INVENTION

The present invention relates generally to a printer configured for printing to media traveling along different paths, particularly different forms of media, and optionally recording digital information thereto.

### BACKGROUND

Print manufactures currently provide consumer with printers configured for printing to different forms of media. Such media includes paper media (such as letters, envelopes, labels or other commonly used paper products), disc media (such as compact disc or digital video disc), or otherwise. Recently, print manufactures have attempted to combine these print capabilities into a single printer, wherein the printer is configured for printing to both paper media and disc media.

However, these printers have failed to provide an efficient user friendly printer. As an example, in order for these printers to function properly, they require the use of removable cartridges for loading disc media into the printer. This removal is necessary because the cartridges occupy at least a portion of the space which is used to print to the paper media. Upon completion of printing to paper media, in order to print to a disc, the removable cartridges must be aligned with an opening of the printer and inserted to load the disc or reassemble the printer. If the user wishes to print to paper media again, the cartridge must be removed from the printer.

Accordingly, at a minimum, there is a need for a more efficient print device capable to printing to multiple forms of media. Also, there is a need for a printer capable of printing to different forms of media without required structural modifications to the printer such as removal of one or more components or otherwise.

### SUMMARY OF THE INVENTION

The present invention meets the above needs by providing an apparatus and method for printing to multiple media traveling along different paths, particularly different forms of media, without necessary removal of components or other structural modification to the printer. In one aspect, this is achieved by providing a printer having multiple media paths for moving media through the printer, wherein the print mechanism is configured to print along the multiple media paths. This may be achieved through the use of a moveable print head or through close placement of the media paths at the pint location. Optionally may include one or more digital recording devices for recording information to certain forms of media, particularly recordable disc media.

In one aspect, the present invention provides a printer adapted to print to multiple forms of media. The printer includes a first media input for receiving a first media and guiding the first media along a first path and a second media input for receiving a second media and guiding the second media along a second path. The printer also includes a print mechanism movable along a first axis. The operation of the printer is achieved through the use of a control unit for controlling movement of the first and second media along the first and second path and for controlling movement of the print mechanism. The control unit selectively causes printing to the first media or second media without necessary removal of the components of the first or second media input, such as a tray or otherwise.

In another aspect, the present invention provides a dual media printer. The printer includes a first media input for receiving a first media and guiding the if first media along a first path and a second media input for receiving a second media and guiding the second media along a second path. The printer also includes a print mechanism movable along a horizontal axis, the print mechanism includes a print head moveable along a vertical axis and is configured to move generally perpendicular to the first and second path. A control unit is also provided for controlling movement of the first and second media along the first and second path and for controlling movement of the print mechanism, and wherein the control unit selectively prints to the first media or second media.

Optionally, the printer may further include print mechanism configured for printing along more than one plane (e.g. generally horizontal or otherwise). The print mechanism may include a movable print head adapted to move with respect to a traversing member if the print mechanism. Furthermore, the print head may be configured for movement towards and away from the media path. Accordingly, the print mechanism is configured to print along multiple planes or media paths for printing to the media located thereat.

Another optional feature includes a recording device for recording digital information to a media device (e.g., a compact disc, digital video disc, or His otherwise.) In one configuration, the recording device is in communication with the first or second media input and is located along a media path. The recording device may be configured to remove media from the media path, record digital information thereto, and return the media to the media path. However, other configurations are described herein and are fully contemplated.

It should be appreciated that any of the above features of the present invention may be combined to form other embodiments of the present invention. Also, it should be appreciated that additional features of the present invention are also available as shown and described herein.

### DESCRIPTION OF THE DRAWINGS

FIG. 1 illustrates a simplified perspective view of one exemplary embodiment of a printer according to the teachings of the present invention.

FIG. 2 illustrates a simplified cross-sectional view of the exemplary embodiment shown in FIG. 1.

FIG. 3 illustrates a simplified top view of one exemplary embodiment of a print mechanism according to the teachings of the present invention.

FIG. 4 illustrates a simplified side view of the exemplary embodiment of the print mechanism shown in FIG. 3.

FIG. 5 illustrates a simplified top view of one exemplary embodiment of a print tray according to the teachings of the present invention.

FIG. 6 illustrates a simplified cross-sectional view of the exemplary embodiment of the print tray shown in FIG. 5.

FIG. 7 illustrates another simplified cross-sectional view of the exemplary embodiment of the print tray shown in FIG. 5.

FIG. 8 illustrates a simplified cross-sectional view of an exemplary recording device according to the teachings of the present invention.

FIG. 9 illustrates a simplified cross-sectional view of another exemplary recording device according to the teachings of the present invention.

### DETAILED DESCRIPTION OF THE INVENTION

The present invention provides a printer capable of printing along multiple planes or paths and/or to multiple forms of media without necessary structural modification or adaptations thereto, such as removal of printer components or otherwise. In one aspect, this includes the ability to print to paper media and disc media without having to add or remove components of the printer such as a disc feeding tray, disc cartridge or the like, By removing this additional step, this feature, at a minimum, reduces the print time necessary to print to both disc media and paper media. For example, this removes the additional step of aligning a disc feeding tray with an opening formed in the printer for printing to discs.

In another aspect, the present invention provides a printer having a print mechanism configured for movement towards and away from one or more media paths for providing the ability to print to media located at different heights, or media having different thicknesses, or both. As in the previous aspect, this may or may not be performed in conjunction with the removal of printer components. Other advantages of the present invention should be appreciated as shown and described herein

The printer is configured for printing to a first media type such as paper products and the like (e.g. sheets, envelopes, labels, or otherwise) and for printing to a second media type such as recordable media (e.g., compact disc, digital video disc, tapes, or otherwise). However, the first and second media type may be the same or different. In one preferred configuration, the first and second media types are different. Also, it is contemplated that the first, second or both media comprises a rigid or flexible media. In one configuration, the first media comprises a flexible media and the second media comprises a rigid media.

The different forms of media are selectively engaged and transported adjacently to a print region where a print mechanism is generally located. The print mechanism then prints to the media and subsequently presents the completed product to the user. It should be appreciated that in this selective printing to the different forms of media, the printer does not require structural alteration to be able to print to these different forms of media, such as removal of a disc tray or otherwise. However, this is not to say that removal of such items cannot be made.

In another aspect of the present invention, the printer may be configured with a print mechanism capable of printing to media located along different planes of the printer. For example, the print mechanism may be configured to print to a first media along a first path and a second media along a second media path, wherein the first and second media paths do not coexist, wherein the first and second media paths, at a print region, are located at different planes, different height with respect to the base or the printer, or otherwise. Accordingly, the printer may be configured to print along one or more axes's or planes corresponding to the first and second media paths. In such a configuration, the print mechanism may include a movable print head adapted to move generally perpendicular to the first and second media path to a position adjacent to the first or second media path,

Also, the print mechanism may be configured to move based upon the type of media being printed thereto. For example, media placed within the printer along the first or second media paths may have varying thickness. The printer may include one or more sensors to determine the thickness or type of the media, or the type or thickness of the media may be manually entered. The sensor may be an optical sensor to measure distance to the media or a displacement sensor use to measure to displacement of one or more feed rollers or otherwise. Thereafter, the print mechanism may move with respect to the first and/or second media path to correspond to the thickness (or other characteristics) of the media.

In yet another aspect, the printer may also be configured with a recording device for recording digital information to media, such as a compact disc, digital video disc or otherwise. Preferably, the recording device is placed adjacent to the first or second media paths. Upon movement of the media device proximate to the recording device, the recording device records information to the media. If printing to the media is desired, the recording may take place prior to or after printing to the media device. It should be appreciated that the recording of the information to one media (e.g. disc) may take place during printing to another media (e.g. paper).

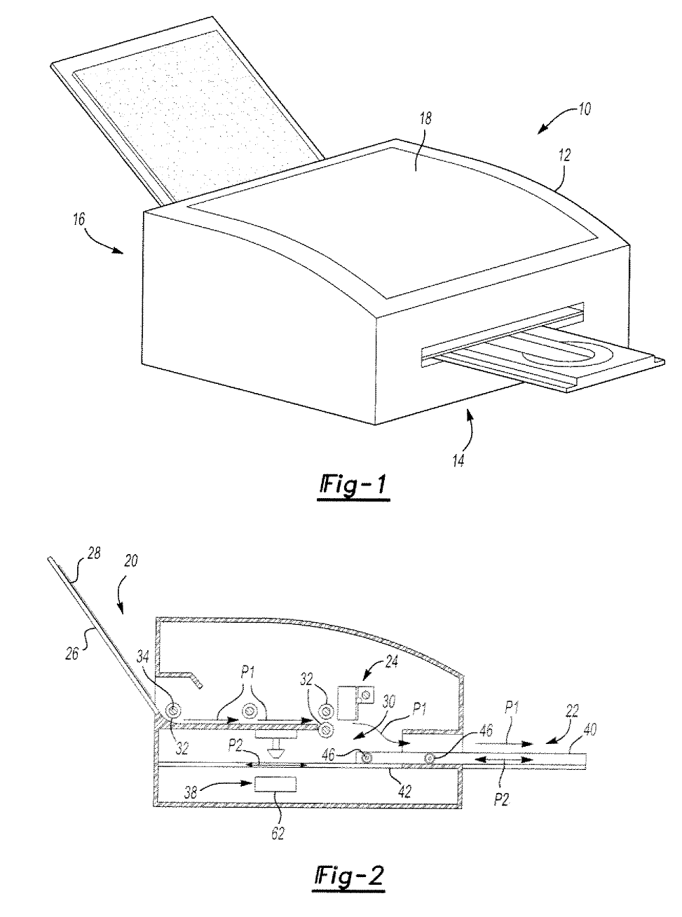

In view of the foregoing, FIGS. 1-9 illustrate exemplary embodiments and features of a printer 10 according to the teachings of the present invention. The printer includes a housing 12 having a front portion 14 and a rear portion 16. The front and rear portions are configured for loading media for printing thereto, presenting completed printing projects to a user, or otherwise. Also, the housing may be configured for supporting various components of the printer as described herein, shown or otherwise. Optionally, the printer may include a cover 18 for providing access to components of the printer or otherwise. Furthermore, the housing may also include one or more support trays, or the like, for guiding or receiving media from the printer,

The front and rear portion of the housing includes a first media input 20 and a second media input 22, respectively, adapted for receiving media devices for subsequent printing thereto, via a print mechanism 24. While the first and second media inputs may be configured for receiving the same forms of media, in a preferred embodiment, the first and second media inputs are configured to receive different forms of media. Suitable forms of media that may be used with the present invention include fibrous cellulose materials such as paper products (e.g., sheets, envelopes, labels or otherwise). Other suitable forms of media include recordable devices, particularly disc, (e.g., compact disc, digital video disc or otherwise). It should be appreciated that other forms of media may also be used with the present invention. The first, second, or both media may be rigid or flexible.

Referring to FIGS. 1 and 2, the first media input is located at the rear portion of the housing and may include one or more guides 26 for assisting in the placement of a first media 28 within the first media input. In this configuration, the first media comprises a flexible media such as paper media, or the like, as described herein. Similarly, the printer may include additional guides, platforms, trays or the like, located at the front portion of the housing, for receiving media exiting from the printer. The one or more guides, or otherwise, are preferably configured for receiving one or a plurality of paper media. It should be appreciated that the guides may comprise a separate component attached to the housing or are integrally formed therewith.

The first media input further includes means for selectively engaging media from the media guide or otherwise and guiding the media into the printer and along a first path P1, which preferably run adjacent a print location 30 and more preferably, substantially juxtapose to a print surface of the print mechanism. The first path extends through the printer such that the paper enters the rear portion of the housing and exist the front portion of the housing. In one configuration, the engaging feature comprises one or more, and preferably a plurality of, rollers 32 adapted to engage and draw paper media into the printer and along the first path, Preferably, the rollers are adapted to selectively engage a single paper media. Accordingly, once the paper media s drawn into the printer, one or more additional rollers engage the paper media and further move the paper media to the print location and through the printer.

Suitable rollers are well known in the art of printer technology. The rollers may comprise a plurality of rollers attached to one or more shafts 34 adapted for rotational movement. Upon activation of one or more of the shafts, preferably in opposite rotational direction, at least one of the rollers engages the paper media thereby drawing the paper media between the rollers and through the printer. This rotational movement may be achieved by an electric driver or other suitable drive means. While both shafts may be rotatably driven, it is contemplated that one of the shafts may comprise a slave shaft driven by the other shaft through the rollers, gears, belts or otherwise. Other configurations should be appreciated.

By example, another suitable roller configuration for moving paper along a media path of a printer that may be used with the present invention can be found in U.S. Pat. No. 7,059,697, to Takahashi et al., the contents of such is herein expressly incorporated by reference for all purposes. In this example, the rollers selectively engage media and move the media along a media path to a print region. Upon completion of printing, the rollers eject the media from the printer. Other configurations are available and known in the art.

The second media input 22 is preferably located at the front portion 16 of the printer 10. The second media input is configured for receiving a second media 36. In this configuration, such media preferably is provided in individual forms such as a disc, tape, or otherwise. Suitable disc that may be used with the present invention include compact disc (CD), digital video disc (DVD), or the like. Still further, it is contemplated that the second media input may be configured to receive yet other forms of media such as records, tapes, or otherwise.

The second media input also includes means for moving media through the printer and along a second media path P2. Preferably, the second media path is adjacent to the print mechanism and more preferably, substantially juxtapose to a print surface of the print mechanism, Furthermore, in one configuration the second media path is also adjacent to a recording location 38.

In the configuration shown movement of the second media through the printer includes a moveable tray 40 this is configured for receiving and holding the second media, such as a disc. The tray moves from an extended position (e.g., wherein at least a portion of the tray is outside of the printer for receiving a disc) and one or more retracted position within the printer. Preferably, the printer further comprises a track 42, or the like, for guiding the movement of the tray. Further, the movement of the tray may be achieved using suitable drive mechanism 44. In one configuration the suitable drive mechanism comprises a geared member 46 adapted to matingly engage with corresponding gears 48 associated of the tray. Accordingly, upon rotation of the drive motor, the geared member rotates and engages the tray to cause movement of the tray along the track to a print location and a recording location.

By example, another suitable tray configuration, and drive mechanism therefor, that may be used with the present invention is shown and described in U.S. Pat. No. 6,341,114, to Nguyen et al., the contents of which are herein expressly incorporated by reference for all purposes. In this example, a loader platform is provided for movement of a disc to various locations, including a recording sight for an optical recording device. Other configurations should be appreciated such as belt drives or otherwise, and are known in the art.

As previously mention, the printer further includes one or more print mechanisms 24 adapted for printing to first or second media moving along the first or second media paths. The print mechanism includes a traversing member 50 adapted to slidably move along the length of the printer, via a slide member 52 or the like. The traversing member may be driven by a belt member or the like or it may include one or more internal traversing mechanism for causing movement along the slide member. Preferably, the movement of the print mechanism is perpendicular to the first and second media paths to be configured to cause printing to the media moving therethrough.

The print mechanism also includes one or more print heads 54 (and associated ink cartridges, toners or otherwise) for printing to the media moving along the first and/or second media paths. The traversing member and the print head may be moveably attached (e.g. slideably or otherwise) with one another In one embodiment, the print head comprises a non-impact configuration. Suitable non-impact print heads include printing means such as inkjet, laser, solid ink, dye-sublimation, thermal wax, thermal autochrome, or other non-impact printing means. However, in one preferred embodiment, the print head comprises an ink jet print head, or the like,

The drive mechanism for the print mechanism may include any suitable drive mechanism configured for moving a print assembly along an axis, or in some instances along a slide member. By example, another suitable drive member that can be used with the present invention can be found in U.S. Pat. No. 7,059,697, to Takahashi et al., herein expressly incorporated by reference for all purposes. Other configurations are available and known in the art.

Optionally, it is contemplated that the print head may be vertically movable with respect to the traversing member, or otherwise. Accordingly, the print mechanism may include a vertical drive member 56 for moving the print head up and down with respect to the traversing member. This capability allows for a broader range of printing adaptation to different forms of media that may be used with the printer. Accordingly it is contemplated that printing to media may be it achieved at a plurality of different heights or distances with respect to the traversing, slide member, or otherwise. For example, the print head may be moved to a first height for printing to the first media and a second height for printing to the second media. Still further, it is contemplated that the print mechanism may adjust to compensate to the thickness of different forms of media in response to a height or thickness indication of the media through a sensor as described herein.

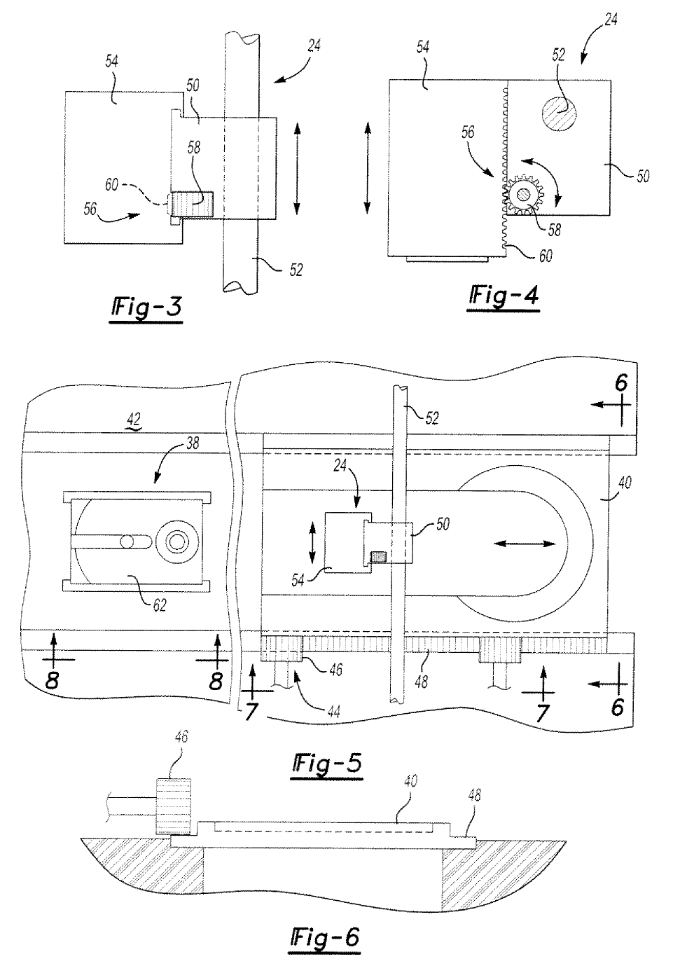

Referring to FIGS. 3 and 4, an exemplary suitable vertical drive member is show. In this configuration, the drive member comprises a geared member 58 attached to the traversing member. The geared member is configured to engage with corresponding gears 60 of the print head. Upon rotational movement of the geared member, via a suitable drive motor, the print head movably slides with respect to the traversing member, it should be appreciated that other configurations are available. For example, the geared member may be located on the print head for engaging the traversing member.

In view of the optional vertical movement of the print head, it is contemplated that the position of the print head may be dependent upon the location of the printable surface of the first or second media. Accordingly, in one embodiment, the printer may further include a sensor for determining the thickness of the media to be printed to. Such sensors may comprise position sensor configured to measure the distance between two corresponding rollers, or otherwise, to determine the thickness of the media. Alternatively, the sensors may comprise an optical sensing device for determining the distance to a media, as compared to the distance to the housing supporting the media. In another configuration, the thickness of the media may be predetermined by a user, or otherwise, and the printer is calibrated to correspond to the thickness of the media entering the print area. This calibration may be preformed manually, through programming of the printer, or otherwise. Upon calibration, the print head moves to a position adjacent to the first or second media path for printing to the surface of the media

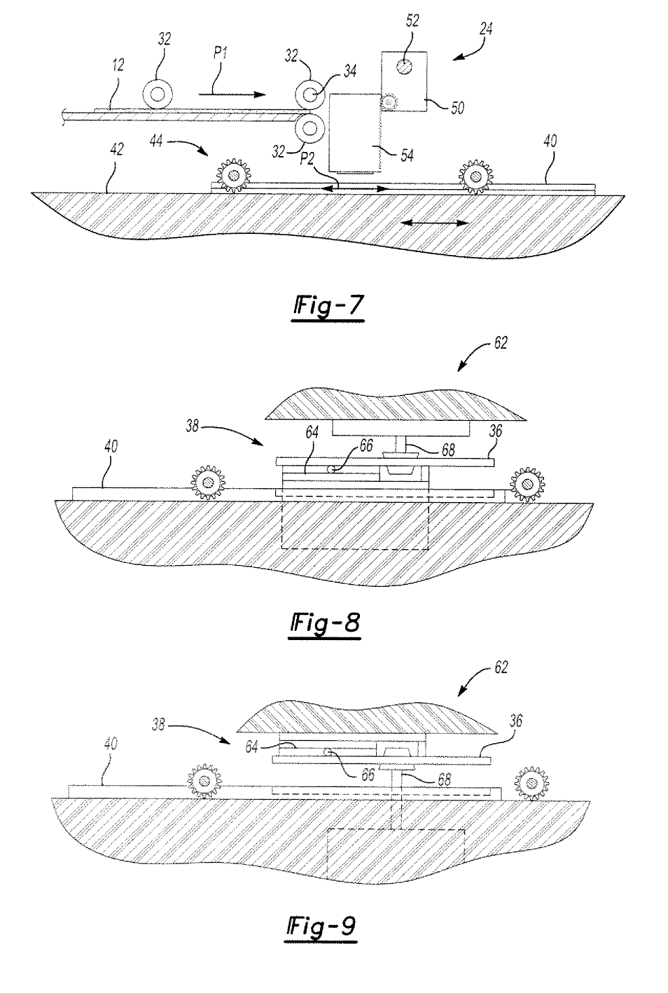

Alternatively, the print head may be adjust in height based upon the form of media being used, e.g., the printer may adjusted based upon the thickness of the media entering the first media input and the second media input. For example, referring to FIG. 2, the print head may be located at a first position to print to the media moving along the first path. In printing to media moving along the second media path, the print head moves to a second position, as shown in FIG. 7, adjacent to the second media path. It should be appreciated that the distance between the first and second position may be greater or less than what is shown in the drawings. However, in one configuration, the distance between the first and second positions may be minimal or negligible such that the print head is not required to move to cause printing to the media moving along the first and second paths.

Optionally, the printer may further include a recording device 62 for recording digital information to a recordable media disc, The recording device may be a separate component capable of receiving and recording to a media disc or it may be integrated or associated with the first or second input means.

By example, two suitable digital recording device that may be used with the present invention include U.S. Pat. Nos. 6,839,310 and 6,434,087, the contents of which are herein expressly incorporated by reference for all purposes.

For example, in one exemplary embodiment, as shown in FIGS., 2, 5, 8 and 9, the recording device may be associated with the second media input and located adjacent the second media path. The recording device includes a disc support member 64 configured for providing support to a media disc, an optical recording means 66 for recording digital information to the disc, and a rotation member 68 for providing rotation movement of a disc. It should be appreciated that the disc writer may be configured for writing information in different compression format such as those formats found in compact disc, digital video disc, or otherwise.

Preferably, the disc support member is configured to remove the disc from the tray to reduce interference during spinning of the media disc. Accordingly, as shown in FIGS. 8 and 9, the recording device further includes means for moving a disc from the tray and to a recording location.

As shown in FIG. 8, the recording device may be integrated with the second media input, By way of the second media input, the media disc is transported along the second media path to the recording area, The movement of the disc to the recording region is achieved using the geared member and tray as previously discussed or otherwise. Once at the recording location, the disc is raised from the tray by the disc support member, using a gear configuration, or otherwise. Upon raising, the disc engages the disc rotation member and provides rotation to the disc. During rotation the recording means records data to the disc. Upon completion, the disc is lowered back onto the tray and moved to a print location or otherwise.

Alternatively, referring to FIG. 9, the disc may be raised from the tray by the rotation member. The rotation member raises the disc until it is adjacent, and preferably juxtapose, to the disc support member. The disc rotation member then rotates the disc and data is recorded to the disc, via the recording means. Upon completion, the disc is lowered back onto the tray and moved to a print location or otherwise.

Control of the printer may be achieved through a processing unit. In one configuration, the processing unit is integrated with the printer. The processing unit may include one or more inputs and software for controlling the functions of the printer. Accordingly, in one embodiment, the printer includes one or more inputs externally located for allowing a user to control one or more functions of the printer. This may include movement of media through the first or second media inputs along the first or second media paths. This may also include printing to media from the first or second media input or recording information to a disc media. Other functional capability are available and within the scope of the present invention.

Alternatively, in another configuration, control of the printer may entirely or in part be achieved through a computer or other remote device. Accordingly, the printer may include one or more ports for allowing communications between the printer and the remote device. The remote device may include software adapted for controlling the functions of the printer and/or for the selection of a print job. In one configuration, the printer may be configured with a processing unit and includes means for being remotely controlled. Other control configuration of the printer should be appreciated by one skilled in the art.

By example, another suitable control unit that may be used with the present invention is found in U.S. Pat. No. 7,059,697, to Takahashi et al., the contents of which are herein expressly incorporated by reference for all purposes.

In one configuration of operation, the user selects one or more print functions to be performed. This may include printing using the first media input, second media input or both. The user places the media proximate to the first and/or second media input as described herein and initiates printing through a remote device.

In printing through the first media source, the user places paper media proximate to the first media input, preferably in a guide. An engaging feature, such as a roller, selectively engages media and moves the media along the first media path. Once the paper media is proximate to the print region, the engagement feature and the print mechanism synchronously operate to cause printing to the sheet. Once printing is complete, the rollers eject the paper media through the front portion of the printer and preferably into a tray, platform or the like for presentation to the user. Upon completion, the printer is ready to print to another media through the first or second media input.

In printing through the second media source, the user places a single disc media in the tray, which is extended from the printer, The printer moves the tray along the second media path to the print location. Once the disc is proximate to the print region, the tray and the print mechanism synchronously operate to cause printing to the disc. Optionally, upon completion, or prior to printing, the tray moves the disc to a recording location. The disc is then removed from the tray, via the recording device, and digital information is recorded thereto. The disc is then returned to the tray and presented to the user, or otherwise,

In printing to the first and second media, as described above, it should be appreciated that, as described herein, the print head may move with respect to the first and second media paths to print to the first and/or second media.

While the embodiment shown herein have illustrated a first and second media input, paths and associated components, it should be appreciated that the printer may include a plurality of paper media inputs and perhaps more advantageous a plurality of disc media inputs. In these configurations, it may be possible to record information to a first disc, and print information to a second disc. Accordingly, it is contemplated that printer may include a plurality of recording device, or each disc media input may include an associated recording device.

One unique aspect of the present invention is that, in contrast to known disc print devices, it is not required that the disc tray of the second media input be removed from the printer in order to print using the first media devices Accordingly, alignment of a disc tray with a printer is no longer required. Furthermore, this feature improves print speed as it removes this alignment step. However, it should be appreciated that in one alternative design the printer may be configured with a removable tray.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only several illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the is following claims should be studied to determine the true scope and content of the invention.

1. A printer adapted to print to multiple forms of media, the printer comprising:
a first media input for receiving a first media and guiding the first media along a first path;
a second media input for receiving a second media and guiding the second media along a second path;
a print mechanism movable along a first axis; and
a control unit for controlling movement of the first and second media along the first and second path and for controlling movement of the print mechanism, and wherein the control unit selectively prints to the first media or second media without complete removal of the first or second media input from the printer.

2. The printer of claim 1, wherein the print mechanism is also movable along a second axis and is configured to move generally perpendicular to at least a portion of the first and second path.

3. The printer of claim 1, wherein the printer further includes a recording device adjacent to the first or second path for recording digital information to the first or second media.

4. The printer of claim 1, wherein one of the first or second media comprises paper and the other comprises a disc.

5. The printer of claim 1, wherein the print mechanism includes one or more inkjet print heads.

6. The printer of claim 1, wherein the first media comprises paper and the first media path extends through the printer and generally perpendicular to the first axis of the print mechanism.

7. The printer of claim 6, further comprising a plurality of rollers for guiding the paper along the first media path.

8. The printer of claim 1, wherein the second media comprises a disc and the second media path extends at least partially through the printer and generally perpendicular to the first axis of the print mechanism.

9. The printer of claim 8, wherein the printer further includes a recording device adjacent to the second media path and wherein the recording device is configured for movement of the disc or recording device for recording digital information to the disc.

10. The printer of claim 8, wherein the second media guide includes a tray moveable along a track to the recording device, the print mechanism and the second media input.

11. The printer of claim 10, wherein the print mechanism includes a print head which is configured to move along a second axis such that the print head is located adjacent the disc surface during printing thereto.

12. The printer of claim 11, wherein the print tray does not require removal from the printer during printing to the first media.

13. The printer of claim 1, wherein the printer includes yet additional media inputs for receiving additional media and guiding the additional media along additional paths, and wherein the print mechanism is configured for printing to the additional media along the additional paths.

14. A dual media printer adapted to print to multiple forms of media, the printer comprising:
a first media input for receiving paper from a source and guiding the paper along a first path to a first media output;
a second media input for receiving disc and guiding the second media along a second path to one or more locations, wherein the second media input includes a tray for guiding the disc along the second path;
a print mechanism movable along a generally horizontal axis and a second generally vertical axis, the vertical and horizontal axis' being generally perpendicular to the first and second media paths;
a recording device located adjacent the second media paths, the recording device or disc being movable to place the recording device and disc proximate one another for recording digital information to the disc; and
a control unit for controlling movement of the first and second media along the first and second path and for controlling movement of the print mechanism, and wherein the control unit selectively prints to the first media or second media without complete removal of the first or second media input from the printer.

15. The printer of claim 14, wherein the print mechanism moves along the vertical and horizontal axis to move proximate the first and second media paths and for printing to the disc and the paper.

16. A dual media printer, the printer comprising:
a first media input for receiving a first media and guiding the first media along a first path;
a second media input for receiving a second media and guiding the second media along a second path;
a print mechanism movable along a horizontal axis, the print mechanism including a print head moveable along a vertical axis and is configured to move generally perpendicular to the first and second path; and
a control unit for controlling movement of the first and second media along the first and second path and for controlling movement of the print mechanism, and wherein the control unit selectively prints to the first media or second media.

17. The printer of claim 16, wherein the first and second media are of the same form.

18. The printer of claim 16, wherein the first and second media are of a different form.

19. The printer of claim 18, further comprising a recording device adjacent to the first or second path for recording digital information to the first or second media.

20. The printer of claim 16, wherein the first media comprises paper and the second media comprises a disc.
